(19) United States
(12) Patent Application Publication
(10) Pub. No.: US 2007/0254071 A1
(43) Pub. Date: Nov. 1, 2007

(54) Method of making a frozen food product

(75) Inventors: Skip Rosskam, Huntington Valley, PA (US); Mitchell Duffy, Titusville, NJ (US); Margaret Pellichero, Warminster, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: David Michael & Co., Inc.

(21) Appl. No.: 11/414,487

(22) Filed: Apr. 28, 2006

(51) Int. Cl. A21D 13/00

(52) U.S. Cl. 426/95

(57) ABSTRACT

A method of making a frozen food product includes the steps of providing a liquid batter and frying the batter in the form of first and second casing halves each having an inner surface defining an interior. A confection adapted to harden when frozen is placed into the interior of each of the first and second fried casing halves such that the interior of the casing half is substantially filled by the confection. The casing halves are then placed in an opposing relationship with each other such that the confection within the interiors of the casing halves collectively forms an inner core substantially enclosed by the casing halves. According to one embodiment, the confection of the inner core is ice cream and the product includes a moisture barrier layer on inner surfaces of the fried casing halves and a coating layer encapsulating the casing.

### FIELD OF THE INVENTION

The present invention relates generally to frozen food products and, more particularly, to a method of making a dessert product comprising a fried batter casing enclosing a core of a frozen confection such as ice cream and the like.

### BACKGROUND OF THE INVENTION

Frozen food products include food products having an outer casing of a fried batter enclosing an inner core of a confection, such as ice cream, adapted to harden when frozen and melt when unfrozen. It is also known to include a barrier layer between the inner confection core and the fried casing to limit propagation of the confection core into the fried casing when the confection core melts.

In prior food products having a fried batter casing and an inner confection core, the batter forming the casing is fried with the confection core located within an interior of the casing. What is needed is a method of making a frozen food product having a fried batter casing enclosing a confection core in which the batter casing is fried before the confection of the product is placed into the casing.

### SUMMARY OF THE INVENTION

According to the present invention, a method of making a frozen food product is provided. The method comprises the steps of providing a liquid batter adapted to be cooked by frying the batter. The batter is fried in the form of a first casing half and a second casing half each having a concave surface defining an interior. A confection adapted to harden when frozen is placed into the interior of each of the first and second casing halves such that the interior of the casing half is substantially filled by the confection. The casing halves are then placed in an opposing relationship with each other such that the confection within the interiors of the casing halves collectively forms an inner core substantially enclosed by the casing halves.

According to one embodiment of the invention, the confection core includes ice cream and a moisture barrier layer is applied to an inner surface of each of the fried casing halves. A coating layer is applied to the fried casing to encapsulate the casing and the confection core within the coating layer.

According to an exemplary procedure for frying the batter, a tool including a mold body having a convex outer surface is provided. The mold body of the tool is heated and dipped in the liquid batter to adhere a portion of the batter to the convex outer surface of the mold body. The mold body and the adhered batter portion is then dipped in a frying oil to cook the batter.

According to an exemplary procedure for placing the confection in the casing halves, the confection is extruded into the interior of a casing half from a dispensing device. The confection is then smoothed such that a substantially level surface for the confection is formed.

According to one embodiment, the frozen food product is toroidal in shape. According to another embodiment, the frozen food product is spherical in shape.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIG. 1 is a perspective view of a frozen food product according to a first embodiment of the invention.

FIG. 2 is a section view of the food product of FIG. 1 taken along the line 2-2 in FIG. 1.

FIG. 3 is a perspective view of a fried casing half of the food product of FIGS. 1 and 2.

FIG. 4 is a perspective view of a tool for making the fried casing half of FIG. 3.

FIG. 5 is a flow chart illustrating a method of making a frozen food product according to the present invention.

FIG. 6 is a flow chart illustrating an exemplary procedure for frying a batter in the form of the casing halves of FIG. 2.

FIG. 7 is a flow chart illustrating an exemplary procedure for placing a confection within the interiors of the fried casing halves of FIG. 2.

FIG. 8 is a perspective view of a spherical food product according to a second embodiment of the invention.

FIG. 9 is a sectional view taken along the line 9-9 of FIG. 8.

### DESCRIPTION OF THE INVENTION

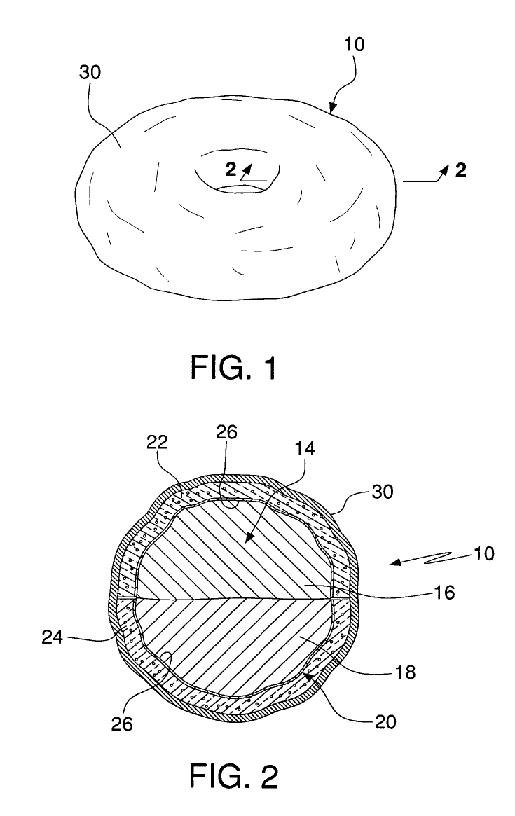

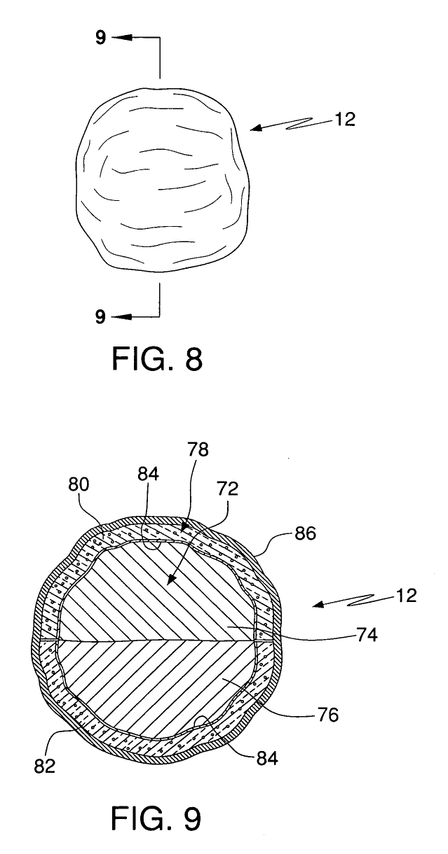

Referring to the drawings, where like numerals identify like elements, there is illustrated in FIGS. 1 and 2 a frozen food product in the form of an ice cream donut 10 according to an exemplary embodiment of the invention. As shown, the ice cream donut 10 is toroidal in shape. The invention is not limited to frozen food products having toroidal (i.e., donut-shaped) configurations, however, and may embody other shapes such as a spherical product 12 (FIGS. 8 and 9).

Referring to the sectional view of FIG. 2, the ice cream donut 10 includes an inner core 14 of ice cream including first and second half-segments 16, 18. Although ice cream is presently preferred as the frozen confection for the inner core 14, it is conceivable that the core could be made from other frozen confections such as ice milk or sherbert, for example. According to one preferred embodiment, the ice cream comprises an ice cream mix including approximately 12 percent butterfat to which a flavoring and/or coloring is adding under agitation. Suitable flavorings adapted for addition to an ice cream mix are provided by David Michael & Company of Philadelphia, Pa. The ice cream flavoring could be used to flavor the ice cream like a filling traditionally used in conventional donuts. For example, a Bavarian creme flavoring could be added to the ice cream mix to simulate a conventional donut filling flavor. Following addition of the flavoring to the ice cream mix and agitation, the ice cream is then preferably frozen to a temperature of approximately 20-25 degrees Fahrenheit, for example using a Taylor Model 104 batch freezer to an overrun of approximately 50-70 percent. The ice cream can then be stored, if desired, at a temperature of approximately 0 degrees Fahrenheit for later use in the method described below for making a frozen food product according to the present invention.

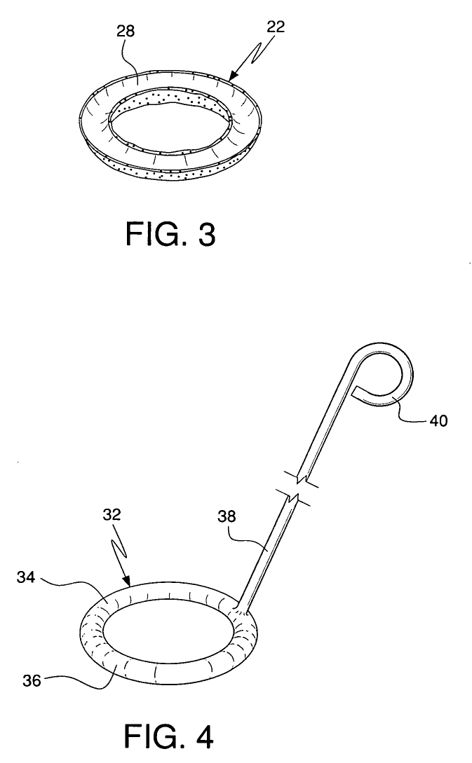

The confection core 14 of the ice cream donut 10 is located within an interior defined by a casing (or shell) 20. The depicted casing 20 is toroidal (i.e., donut-shaped) and includes a first half 22 and a second half 24, respectively forming upper and lower portions of the casing 20 (from the point of view of FIGS. 1 and 2). As described below in greater detail, the halves 22, 24 of casing 20 are made from a fried batter. The depicted ice cream donut 10 includes a layer 26 of a moisture barrier material applied to each of the casing halves 22, 24. The barrier material layer 26 functions to prevent the ice cream from propagating from the inner core 14 into the fried casing 20, particularly during storage of the ice cream donut 10. According to a presently preferred embodiment, the barrier material is a chocolate coating material adapted for coating ice cream bars and the like. Referring to FIG. 3, the first casing half 22 is illustrated after it has been fried from batter, in the manner described below, and before the moisture barrier layer 26 has been applied to a concave inner surface 28 of the casing half 22 that defines the interior of the casing half 22. It should be understood that the second casing half 24, which is preferably fried in the same manner as the first casing half 22, will be substantially identical to the first casing half 22.

Referring again to FIGS. 1 and 2, the ice cream donut 10 also includes a layer 30 of a coating material applied to the casing 20 such that the casing 20, and the ice cream core 14 located within the interior of the casing 20, are encapsulated by the coating layer 30. According to a presently preferred embodiment, the material used for the coating layer 30 is the same chocolate coating material used for the above-described moisture barrier layer 26 on the inner surfaces of the casing halves 22, 24. The encapsulation provided by the coating layer 30 holds the first and second casing halves 22, 24 together in the opposing face-to-face relationship illustrated in FIG. 2 and desirably limits passage of melting ice cream from the interior of the casing 20 (e.g., between the confronting edges of the first and second casing halves 22, 24). The coating layer 30 also functions to hide the seams between the halves 22, 24 of casing 20, thereby giving the finished food product 10 the appearance of a chocolate glazed cake donut even though it is in reality a frozen food product filled with ice cream.

Referring to FIG. 4, there is shown a tool 32 for use in making the casing halves 22, 24 of ice cream donut 10. The tool 32 includes a mold body 34 having a convex outer surface 36 that is toroidal in shape for forming the casing halves 22, 24 in the desired shape shown in FIG. 3 for use in making the ice cream donut 10. It should be understood that the configuration of the convex outer surface of the tool would vary from that shown for forming casing halves of frozen food products having differing shapes. For example, to form the ice cream sphere 12 of FIGS. 8 and 9, the tool 32 would be modified to include a mold body having a spherical outer surface. The tool 32 includes an elongated handle 38 including a loop 40 opposite the mold body 34 to facilitate grasping of the tool 32 by a user. Preferably, the mold body 34 and the handle 38 of tool 32 are both made from a metal, such as stainless steel, and are secured together by welding the handle 38 to the mold body 34.

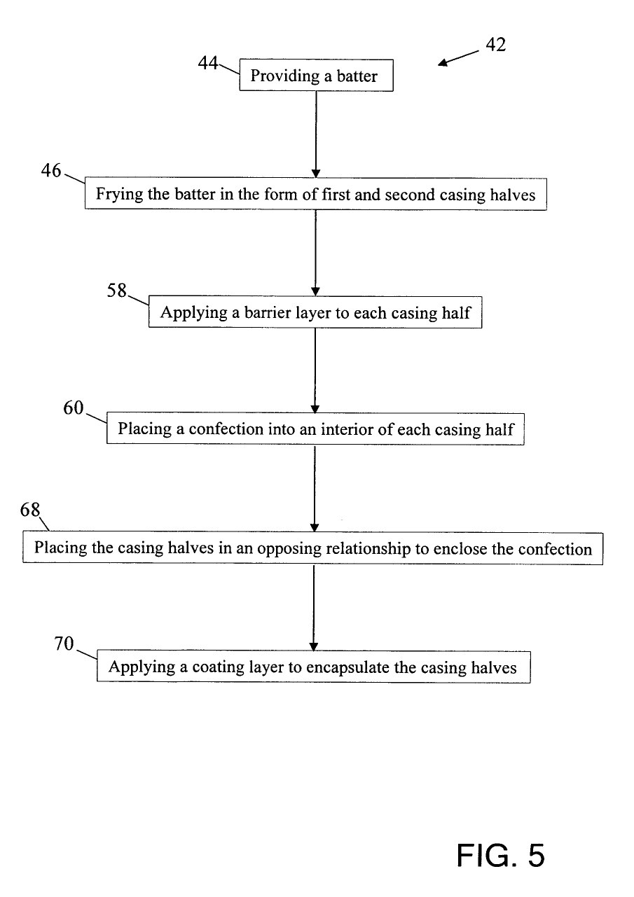

Referring to FIG. 5, the flow chart illustrates a method 42 of making a frozen food product, such as ice cream donut 10 of FIG. 1, according to an exemplary embodiment of the invention. In step 44, a batter is provided that is adapted to be cooked by frying the batter. According to one presently preferred embodiment, the batter is a donut batter including, among other things, water, flour, sugar, cocoa, egg yolks, oil, non-fat dry milk, salt, flavoring, and dextrose. To facilitate the formation and frying of the casing halves 22, 24, in the manner described below, the percentage of water in the batter mixture is preferably greater than about 40% by weight. To facilitate uniform mixing of the batter ingredients, the dry ingredients of the batter recipe are preferably first added together and mixed (e.g., using a planetary mixer with attached paddles at a relatively slow speed). The remaining ingredients are then added to the dry ingredients and the entire composition is mixed until uniform.

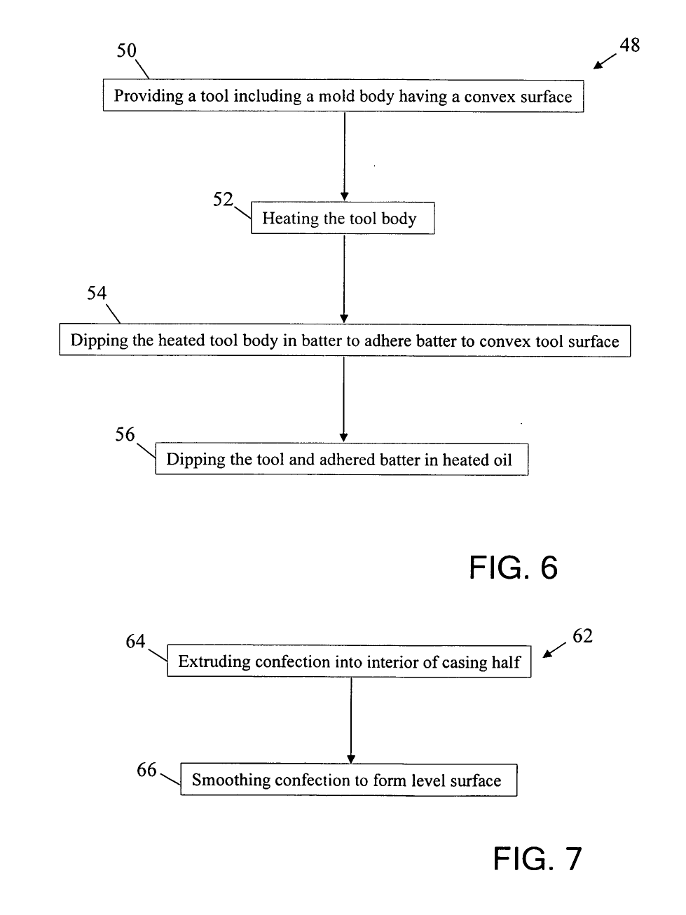

In step 46 of method 42, the batter from step 44 is fried in the form of first and second halves 22, 24 of casing 20. Referring to FIG. 6, there is illustrated an exemplary procedure 48 for frying the batter in the desired form of the casing halves 22, 24. Each of the casing halves 22, 24 is preferably formed in the same manner using frying procedure 48. To facilitate description, the frying procedure 48 is described with respect to the first casing half 22 shown in FIG. 3, it being understood that the same procedure would be used to form the second casing half 24. In a first step 50 of the frying procedure 48, the above-described tool 32 including a mold body 34 having a convex outer surface 36 is provided. In step 52 of frying procedure 48, the body 34 of tool 32 is heated. According to a presently preferred embodiment, the tool body 34 is heated by dipping the tool body 34 in frying oil having a temperature of approximately 375 degrees Fahrenheit. In step 54 of frying procedure 48, the heated tool body 34 is then removed from the frying oil and dipped in the liquid batter from step 44 to adhere a portion of the batter to the convex outer surface 36 of the tool body 34. Preferably, the batter prepared in step 44 has been placed in a container or reservoir at a sufficient depth to provide for dipping of the heated mold body 34 of tool 32 to a sufficient depth to form the desired shape. Thus, to form the half casing 22 shown in FIG. 3, the toroidal mold body 34 of tool 32 is dipped in batter in step 54 such that approximately one-half of the body 34 is immersed in the batter (i.e., hemi-toroidal immersion). The heated mold body 34 is preferably held in the liquid batter for approximately 10 seconds to adhere a portion of the batter to the mold body 34 in the desired shape.

In step 56 of frying procedure 48, the mold body 34 with the adhered portion of the liquid batter is removed from the container of batter and dipped into a heated frying oil at approximately 375 degrees Fahrenheit to cook the batter in the desired form. The frying oil conceivably could be the same frying oil that is used to heat the mold body 34 of tool 32 in step 52. According to one presently preferred embodiment, the portion of batter adhered to the tool body 34 is cooked in the frying oil in two stages as follows. In a first stage, the tool body 34 and the adhered batter portion is held in the frying batter for approximately 10 seconds to partially cook the batter (i.e., the batter remains relatively soft but is capable of being removed form the shell while maintaining the desired form). In a second stage, the partially-cooked batter in the form of half-casing 22 is separated from the tool body 34 (e.g., pried from the tool body 34) and cooked in the frying oil for approximately one minute to fully-cook the casing half 22. The cooked casing half 22 is then removed from the frying oil and placed on a cooling rack with the open end of the casing half 22 facing downward (i.e., inverted from the orientation shown in FIG. 3) to drain the casing half 22. The casing half 22 hardens upon cooling such that the resulting casing 20 provides an enclosure for the inner core 14 that is crispy in texture. If desired, the casing half 22 can be stored until further use in method 42 by placing the casing half 22 in a freezer.

Referring again to the method 42 of FIG. 5, the moisture barrier layer 26 of barrier material is applied to each half 22, 24 of casing 20 in step 58. As described above, the barrier material is applied to the inner surface of each casing half 22, 24 to limit propagation of ice cream from the inner core of the ice cream donut 10 into the casing 20. As described above, a presently preferred material for the moisture barrier layer 26 is a chocolate coating material such as that used to coat ice cream bars and the like. Preferably, the barrier material is heated to a temperature of 90-115 degrees Fahrenheit to melt the material to facilitate application of the material to the casing halves 22, 24. The barrier material can be applied to the inner surface of each casing half 22, 24 by brushing the material onto the inner surface. It is also conceived that the barrier material could be applied by other means, such as by spraying the material onto the surface using an automated sprayer for example.

In step 60 of method 42, the confection of the frozen food product is placed into the interior of each half 22, 24 of casing 20. For the ice cream donut 10 of FIGS. 1 and 2, the confection is ice cream, such as the Bavarian creme flavored ice cream described above. Referring to FIG. 7, there is there is illustrated an exemplary procedure 62 for placing the confection into the casing halves 22, 24. The confection placing procedure 62 is described with respect to the first casing half 22 it being understood that the same procedure would be used to place the confection in the second casing half 24. In step 64, the confection is extruded from a dispensing device into the interior of the casing half 22. In step 66, the confection is then smoothed (e.g., using a scraper or other blade-like element) such that a substantially level surface for the confection is formed with the confection substantially filling the interior of the casing half 22.

Referring again to FIG. 5, and step 68 of method 42, the first and second casing halves 22, 24 are brought into an opposing relationship such that the confection placed in the casing halves 22, 24 is substantially enclosed by the casing 20 as inner core 14. As shown in FIG. 2, the confection is preferably placed in the interiors of casing halves 22, 24 in step 60 such that the confection segments 16, 18 forming the inner core 14 contact each other. Preferably, the filled casing halves 22, 24 are joined together with the ice cream in a relatively softened condition to facilitate contact between the segments 16, 18 of the inner core 14. Such contact between the segments 16, 18 with the ice cream in a softened condition desirably promotes prolonged connection between the segments 16, 18 in an adhered manner. It is conceivable that the filled casing halves 22, 24 could be stored in a freezer prior to step 68 of joining the casing halves 22, 24. If the filled casing halves 22, 24 have been stored in a freezer, sufficient time is preferably provided following their removal from the freezer for the ice cream to soften to promote adherence between the segments 16, 18 in the above-described manner following step 68. The resulting unit having joined halves 22, 24 is then preferably placed in a freezer until the temperature of the inner core 14 is between approximately 0 and −20 degrees Fahrenheit.

In step 70, coating layer 30 is applied to the unit formed in step 68 such that the casing 20, and the confection core 14 within the interior of casing 20, are encapsulated by the coating layer 30. As described above, a presently preferred material to form the coating layer 30 is a chocolate coating material adapted for coating ice cream bars and the like. The coating material is preferably maintained at a temperature of approximately 90-105 degrees Fahrenheit to facilitate application of the coating material. The coating material can be coated by dipping the casing 20 and confection core 14 in the coating material for approximately 5 seconds. The ice cream donut 10 is then preferably placed on a cooling rack to allow excess coating material to drain from the donut 10. When the coating layer has hardened slightly (e.g., after approximately 15-20 seconds), the ice cream donut 10 can be removed from the cooling rack and placed onto a suitable medium such as parchment paper. The ice cream donut 10 is then preferably maintained at a temperature of below approximately 0 degrees Fahrenheit in a freezer until the product is consumed.

As described above, the present invention is not limited to toroidal shaped products. The above described method could be used to form frozen food products having other configurations such as the spherical product 12 shown in FIGS. 8 and 9. The spherical product 12 includes an inner core 72 of ice cream having segments 74, 76 enclosed by a fried casing 78 having first and second halves 80, 82. Each of the casing halves has a moisture barrier layer 84 applied to an inner surface. An outer coating layer 86 encapsulates the fried casing 78 and inner core 72. The resulting spherical food product 12 has the appearance of spherical food products known as “donut holes.” As described above, the method of making the spherical food product is the same as the above-described method of making the ice cream donut 10 except that the mold body of the tool for making the casing halves 80, 82 would have a spherical outer surface instead of a toroidal surface.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method of making a frozen food product comprising the steps of:
providing a liquid batter adapted to be cooked by frying the batter;
frying the batter in the form of a first casing half and a second casing half each having a concave surface defining an interior;
placing a confection adapted to harden when frozen into the interior of each of the first and second casing halves such that the interior of the casing half is substantially filled by the confection; and
placing the first and second casing halves in an opposing relationship with each other such that the confection within the interiors of the casing halves collectively forms an inner core substantially enclosed by the casing halves.

2. The method according to claim 1, wherein the batter is a donut batter.

3. The method according to claim 1, wherein the confection comprises ice cream.

4. The method according to claim 1 further comprising the step, prior to the step of placing the confection, of applying a barrier material to the concave surface of each casing half to limit contact between the concave surface and the confection placed in the interior of the casing half.

5. The method according to claim 4, wherein the barrier material comprises chocolate.

6. The method according to claim 1 further comprising the step, following the step of bringing the first and second casing halves into contact, of applying a coating material to the first and second casing halves such that the casing halves and the inner core are substantially encapsulated by the coating material.

7. The method according to claim 6, wherein the step of applying the coating material includes the step of dipping the casing halves and inner core into the coating material.

8. The method according to claim 6, wherein the coating material comprises chocolate.

9. The method according to claim 1, wherein each of the first and second casing halves is formed by:
providing a tool including a body having a convex surface;
heating the body of the tool;
dipping the heated body of tool into the liquid batter to adhere a portion of the batter to the convex surface of the body; and
dipping the body of the tool and the adhered portion of the batter into a heated oil to fry the batter.

10. The method according to claim 9, wherein the batter is fried in two stages including a first stage in which the tool body and the adhered batter is dipped into the heated oil to partially cook the batter and a second stage in which the batter is placed into the heated oil following separation of the batter from the body of the tool.

11. The method according to claim 1, wherein the step of placing a confection includes the steps of:
extruding the confection from a confection delivery device into the interior of each casing half; and
smoothing the extruded confection to create a substantially level surface for the confection for each casing half.

12. The method according to claim 1, wherein the confection is adapted to harden when stored in a freezer, and wherein the first and second casing halves are placed in the opposing relationship while the confection is in a relatively softened condition to facilitate connection between the first and second casing halves.

13. The method according to claim 1 further comprising the step, following the step of bringing the first and second casing halves into contact, of storing the first and second casing halves in a freezer.

14. The method according to claim 1, wherein the frozen food product is substantially toroidal in shape.

15. The method according to claim 1, wherein the frozen food product is substantially spherical in shape.

16. A method of making a frozen food product comprising the steps of:
preparing a donut batter adapted to be fried in a heated oil;
providing a tool including a body having a convex outer surface;
heating the body of the tool by placing the body in a heated oil;
placing the heated body of the tool in the donut batter to adhere a portion of the batter to the convex outer surface of the body in the form of a first half-shell defining an interior;
frying the first half-shell by placing the body of the tool with the adhered portion of the batter in the heated oil;
repeating the above steps of heating, placing, and frying to form a second half-shell defining an interior;
applying a barrier material to an inner surface defining the interior of each of the first and second half-shells;
extruding a confection adapted to harden when frozen from a dispensing device into the interior of each of the first and second half-shells;
smoothing the confection within the interior of each half-shell to form a substantially level surface for the confection;
bringing the first and second half-shells into contact with each other such that the confection is substantially enclosed by the first and second half-shells; and
applying a coating material to the first and second half-shells such that the first and second half-shells are substantially encapsulated by the coating material.

17. The method according to claim 16, wherein the confection comprises ice cream.

18. The method according to claim 16, wherein the frozen food product is substantially toroidal in shape.

19. The method according to claim 16, wherein the frozen food product is substantially spherical in shape.
